(19) United States
(12) Patent Application Publication
(10) Pub. No.: US 2006/0112011 A1
(43) Pub. Date: May 25, 2006

(54) Electronic banking system

(76) Inventor: Abdulhadi M Al-Ali, Dhahran (SA)

Correspondence Address: Abelman Frayne & Schwab, 150 East 42nd Street, New York, NY, 10017-5612, US

(21) Appl. No.: 10/521,499

(22) PCT Filed: Sep. 16, 2003
(86) PCT No.: PCT/US03/29551

§ 371 Date: Aug. 10, 2005

Related U.S. Application Data
(60) Provisional application No. 60/411,330, filed on Sep. 16, 2002.

(51) Int. Cl. G06Q 40/00

(52) U.S. Cl. 705/42

(57) ABSTRACT

An automated electronic banking system for initiating and automatically processing monetary transactions, includes initiating means for maintaining a transaction record and permitting a remotely located customer of a bank to selectively initiate a monetary transaction request for automated processing, a bank host server adapted for automatically receiving and processing the monetary transaction request, a computer network in data communication between the bank host server means and the initiating means, for transmitting the payment transaction request from the customer's initiating means to the to bank host server, and interface means located between the initiating means and the computer network for automatically interfacing the initiating means to the bank host server, and for converting the monetary transaction request into a readable form compatible with the bank host server, wherein the customer's initiating means periodically receives in response from the bank host server confirmation data for permitting the initiating means to automatically reconcile the transaction record on a daily basis. The present invention is further directed to a method for an automatic electronic banking system for permitting a customer of a bank to remotely authorize and request a computerized monetary transaction to be made by their bank.

### RELATED APPLICATION

This Application claims the benefit of priority from U.S. Provisional Application Ser. No. 60/411,330, entitled “ELECTRONIC BANKING SYSTEM”, filed on Sep. 16, 2002.

### FIELD OF INVENTION

The present invention is related generally to banking, and more particularly to electronic banking systems for facilitating the processing of bank transactions.

### BACKGROUND OF THE INVENTION

Current systems for posting banking or transaction orders (e.g., fund transfers, payment processing and statement and report requests) to banking institutions from customers generally rely on antiquated and manual methods that are time-consuming, inefficient and prone to error and loss. Such systems often rely on paper-based methods, which involve human intervention and physical delivery of paper documents each of which contribute to slow processing rate and undue delay. Parties to a banking transaction must often wait a considerable amount of time for a bank to complete a particular transaction. For larger organizations conducting numerous local and international banking transactions each day, the inefficiencies of current systems become more apparent.

For example, in a typical payment transaction between a vendor and a large customer, the vendor prepares and submits an invoice for delivery to the customer. The customer receives the invoice and forwards it to the corresponding originating department, which originated the dealings with the vendor. The originating department reviews and approves the invoice for payment The approved invoice is then forwarded to accounts payable where a check is prepared. Since the system is a paper-based process, it relies significantly on internal mail correspondences and can take about four weeks to complete. The check is forwarded to an appropriate administrator for verification and signature. The check is then delivered to the vendor. The vendor receiving the check subsequently presents it to the bank for payment This final portion of the transaction involves further time to process (i.e., from one hour to three days), requires human intervention and a retail banking system to complete the transaction. Although the customer may receive a bank statement on a periodic basis or on a real time basis via electronic means (e.g., Internet), it may require twenty to thirty days to reconcile the payment with the invoice of the previous month due to the inefficient check presentment and clearing process. If the check is lost during the process, the process is repeated.

Accordingly, there is a need to provide an electronic banking system which can automatically process banking orders issued by a customer for automatically processing monetary transactions, such as making electronic payments to bank accounts or beneficiaries (i.e., payees) or transferring money between accounts, with minimal delay or human intervention, while utilizing existing hardware, software and communication components. There is a further need for an electronic banking system, which provides accurate real-time assessment of the outstanding liabilities involving accounts with multiple banks, and thus shortening the time needed for reconciling the accounts.

### SUMMARY OF THE INVENTION

The present invention relates to an electronic banking system, which can be used to provide an efficient automated interface between a bank and a customer, wherein the customer can from their location or facility electronically issue a bank order to one of multiple member banks of the system to initiate the automated processing of the requested monetary transaction. The electronic banking system of the present invention can readily be adapted for use with existing hardware, software and communication components. The electronic banking system is further compatible for operation with a range of proprietary retail banking systems through a global computer network. In one particular embodiment of the present invention, there is provided an electronic banking system for automatically processing monetary transactions including transfer of funds into appropriate monetary accounts with minimal delay and human intervention over a local or global computer network (such as the Internet).

In one aspect of the present invention, there is provided an electronic banking system, which comprises:

a host bank server adapted for receiving a transaction request and processing the transaction request;

means for initiating the transaction request in an automated operation;

a global computer network in data communication between the host bank server and the initiating means, for transmitting the transaction request from the initiating means to the host bank server; and

means for interfacing the initiating means to the host bank server and for converting the transaction request into a readable form compatible with the host bank server and establishing a secure data communication connection therebetween.

### BRIEF DESCRIPTION OF THE DRAWINGS

Various embodiments of the invention are described in detail below with reference to the drawings, in which like items are identified by the same reference designation, wherein:

FIG. 1A is a schematic diagram illustrating a payment process as one of the applications facilitated by the implementation of an electronic banking system in accordance with the present invention;

FIG. 1B is a schematic diagram of an electronic banking system in accordance with an embodiment of the present invention;

FIG. 2 is a schematic diagram of the overall architecture of the electronic banking system for one embodiment of the present invention;

FIGS. 3A through 3F represent in combination a flowchart detailing the operational steps of the electronic banking system in payment mode for an embodiment of the present invention;

FIG. 4 is a flowchart detailing the operational steps of the electronic banking system in statement and reconciliation mode for another embodiment of the present invention; and

FIG. 5 is a flowchart detailing the operational steps of the electronic banking system in statement display mode for yet another embodiment of the present invention.

### DETAILED DESCRIPTION OF THE INVENTION

The present invention is directed to an electronic banking system and a method of processing monetary transactions. In one mode of operation, the electronic banking system of the present invention is adapted for automatically processing monetary transactions and making appropriate fund transfers (i.e., payments) into financial accounts in a rapid manner with minimal human intervention. The electronic banking system of the present invention is further adapted to utilize a global computer network such as the Internet, and existing hardware and software components, for example. The present invention can readily be implemented in collaboration with monetary data processing entities including, but not limited to, banks, payment processing centers, financial clearinghouses and the like.

The automated feature of the present invention provides a user, such as a large organization having numerous local and international monetary transactions, with the capability to transact business with banking systems in synchronous mode. This enhances processing times and allows the user to automatically reconcile its payment system with the account records of the banking system in a rapid real-time manner with minimal human intervention.

The primary end users of the system include the treasury users who will access the system to secure approval of the transactions prior to implementing processing. The treasury users are typically part of the group in the large organization responsible for the management of the organization's worldwide real and financial assets, liabilities and risks associated with revenue, investment, debt, foreign exchange, credit and insurance. Thus, the system of the present invention provides a useful tool for enabling the treasury users to maintain and manage the daily financially operations of the organization in an integrated and automated manner.

In one embodiment of the present invention, the electronic banking system includes three main components: a core transaction processing component for generating and initiating monetary transactions, a core interface component for communicating with a bank server via the Internet, and a bank interface component, all of which cooperate to form a communication link with the core interface component while authenticating, validating, transacting and confirming transactions for the present system.

The present invention in its various embodiments can provide the following functions:

1. Electronic fund transfers to third parties;

2. Electronic fund transfers between common accounts in same bank;

3. Electronic fund transfers between common accounts in different banks;

4. General type payments;

5. Automatic end of day electronic bank statement retrieval and reconciliation;

6. Generation of a facsimile payment advice notification to third parties;

7. Generation of a facsimile anticipated payment notification (Sales Revenue Receivables) to recipient Bank;

8. Automated telex functionality to provide backup for the system of the present invention;

9. Generation of cash position reports to indicate customer's financial liability; and

10. Online retrieval of account balance at any of the member banks directly integrated through the system of the present invention.

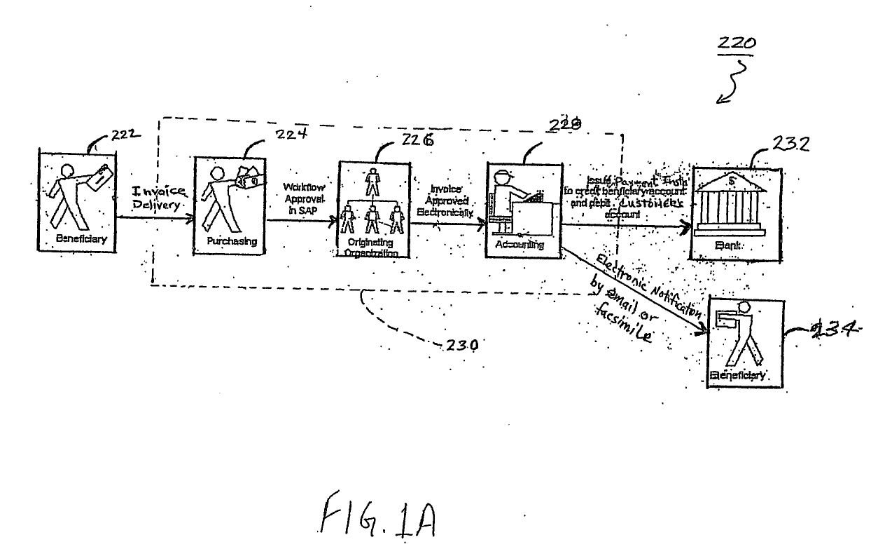

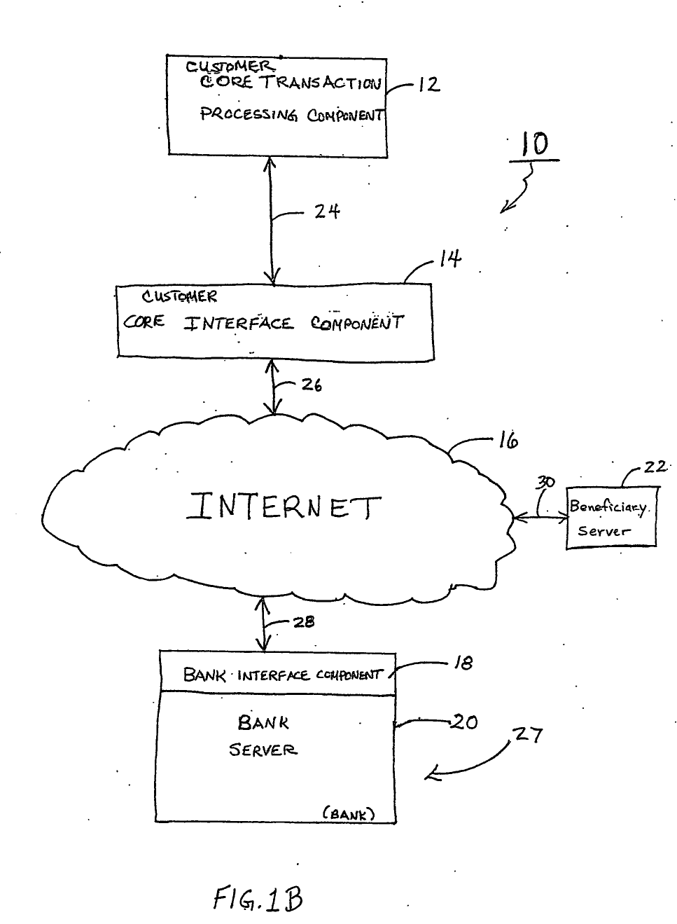

With reference to FIG. 1A, a payment process 220 is shown representing one of several applications facilitated by the present invention. The payment process 220 begins with step 222 in which a beneficiary or payee prepares and submits an invoice for payment to a customer 230 such as an individual, a company or large organization. Assuming the customer 230 is a large enough entity to include purchasing and accounting departments, in step 224, the invoice is delivered to a receiving department of the customer (e.g., purchasing) responsible for reviewing the invoice and directing it to the proper department for further processing and approval. The receiving department inputs the invoice information into a business enterprise or workflow software system where it is conveyed to the proper parties for processing. The invoice information is verified, electronically captured and approved for payment using the electronic workflow approval process, which is coordinated between the Accounts payable department and the originating department which initiated the work. In step 226, the invoice is delivered to the originating department for their review and approval. In step 228, the invoice approval is forwarded to the accounts payable where an electronic payment is prepared in the form of an electronic payment instruction. Steps 224 through 228 are implemented internal within the customer 230 typically via the work flow approval process. In step 232, the customer 230 forwards the electronic payment instruction to the bank via a computer network. The bank 232 then proceeds to process the information and make payment as requested by the customer 230. Simultaneously, in step 234, as the payment instruction is sent to the bank 232, a facsimile notification is forwarded to the beneficiary 222 to confirm that the monetary transaction request has been forwarded to the bank. The monetary transaction may have been made in any of a number of ways, such as by electronically transferring money from the customer's account to a bank account of the beneficiary, or by sending a check to the beneficiary.

With reference to FIG. 1B, there is shown an electronic banking system in accordance with one embodiment of the present invention, and indicated generally by the reference numeral 10. The system 10 includes in series connection a core transaction component 12 which can be a computer server operated by a customer of the banking system; a core interface component 14 in communication with the core transaction component 12, which can in certain applications be supported by the same computer server providing the core transaction component 12, or by a different computer server; a global computer network 16 (e.g., the Internet); and a bank interface component 18 supported by a bank server 20 operated by the customer's bank. The bank interface component 18 is in communication with the core interface component 14 via the global computer network 16. Optionally, the system 10 can further include a beneficiary server 22 connected to the global computer network 16 for communicating with the customer. The core transaction component 12, and the core interface component 14 are installed in the customer's facility.

The core transaction component 12 forms part of the intranetwork system accessible to the customer, and is programmed with a enterprise-based software selected from any standard business software used by organizations for supporting and facilitating collaborative operations in a paperless environment Such software can include, but is not limited to, SAP® R/3® Enterprise ERP available from SAP AG of Germany. Although the electronic banking system of the present invention is shown and described as being programmed with SAP® software and application modules, the present invention is not limited to such software programs, and can be modified by substituting other software known in the art

Once a cash management transaction is reviewed and approved by the user or a designated approval officer of the customer, the core transaction component 12 is programmed to automatically generate an electronic transaction order or payment instruction, which is automatically processed without further human intervention. The generated transaction order is forwarded to the core interface component 14 via data communication link 24. The core interface component 14 prepares the transaction order for transmission (via data communication link 26) over the global computer network 16 to the appropriate bank server 20. The core interface component 14 facilitates communication through the global computer network 16 between the core transaction component 12 and the corresponding bank server 20. The transaction order is transmitted over the global computer network 16 and is received by the bank interface component 18, which can, for example, be a dedicated computer or part of a computer server providing bank server 20 and is programmed to authenticate, validate, transact and confirm the transactions contained within the transaction order. The bank interface component 18 is configured for operation with the particular retail banking system of the bank server 20. The bank interface component 18 prepares the transaction order into a form specific to the retail banking system of the bank server 20. Once the bank server 20 receives the transaction order, the instruction contained in the order is carried out

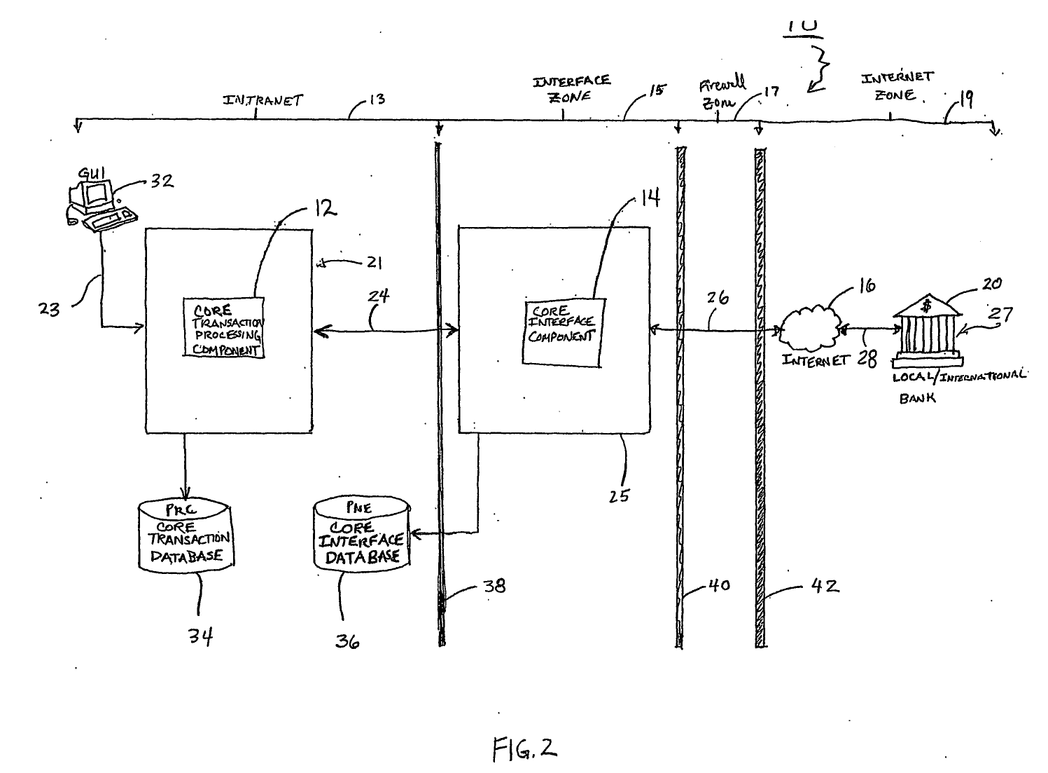

Referring to FIG. 2, the system 10 is shown in greater detail for one embodiment of the present invention. The system 10 comprises an intranet zone 13, an interface zone 15, a firewall zone 17 and a global computer network zone 19. The intranet zone 13 generally comprises a dedicated local server 21 programmed with a enterprise business software system such as, for example, SAP® R/3® an integrated customizable core software system programmed for supporting application modules such as SAP® Treasury Module (SAP-TR) which is a subset of SAP® Financial Accounting Module (SAP FI). Among other functions, the local server 21 performs the operation of the core transaction component 12 in the present invention. The local server 21 is in communication with at least one work station or client computer 32 via a communication link 23 for enabling access to authorized users such as designated personnel of the customer. The client or customer computer 32 supports graphical user interface (GUI) software such as, for example, SAP® GUI Software Version 4.6D.

The intranet zone 13 further includes a core transaction database memory 34 connected to the local server 21 for providing storage and retrieval means for data processed by the local server 21. The core transaction database memory 34 is loaded with a suitable database software such as, for example, Oracle® 5.7.3.

The interface zone 15 comprises an interface server 25 (provides the functions of core interface component 14), which is connected to the local server 21 via a communication link 24 and a firewall 38 established between the local server 21 and the interface server 25. The firewall 38 functions to isolate the customer's intranet zone from the interface zone. Its primary function is to secure data traffic to the interface zone and servers to authorized access by corresponding systems and users. The interface server 25 is programmed with open interface software for implementing communication over the global computer network 16, the Internet in this example, between the core transaction component 12 and the bank server 20. In the preferred embodiment of the invention, the open interface software is developed from SAP® Business Connector, as illustrated in flowcharts described below. The interface server 25 implementing SAP® Business Connector communicates with the local server 21 implementing SAP® R/3 system through Remote Function Calls (RFC). The interface server 25 converts all RFC formatted communications from the core transaction component 12 on the local server 21 into extensible markup language (XML). In the present embodiment, hypertext transfer protocol (HTTP/HTTPS) format is used for communication through the global computer network 16. The interface zone 15 is maintained separate from the global computer network 16 via the firewall zone 17 comprising a pair of firewalls 40 and 42, respectively. The interface server 25 is electronically connected to the global computer network 16 via a communication link 26 extending through the firewalls 40 and 42, respectively. Data transmitted from the interface server 25 is delivered through the global computer network 16 to the bank server 20 via a communication link 28.

The core interface component 14 further includes a core interface database memory 36 connected to the interface server 25. The core interface database 36 is similar to the core transaction database memory 34, and is adapted to provide a storage and retrieval means for all operations associated with the core interface component 14. The core interface database memory 36 is preferably established behind the firewall 38 on the same side as the intranet computer zone 13, as shown in FIG. 2.

In the present invention, the core transaction component 12 generates monetary transaction orders to the appropriate bank server(s) 20 at a customer's bank or banks for conducting monetary transactions, such as making payments or managing cash in the customer's bank account(s). Each of the monetary transaction orders is generated by the SAP® R/3 FI-TR module, in this example, of the core transaction component 12. The transaction orders are prepared in the form of Intermediary documents (IDOC). The IDOCs are forwarded to the interface server 25 where they are converted into XML, and then forwarded to a predesignated bank server 20 at the customer's bank. The predesignated bank server 20 receives the XML, and the bank interface component 18 reformats the XML documents into a format suitable for processing by the bank server 20.

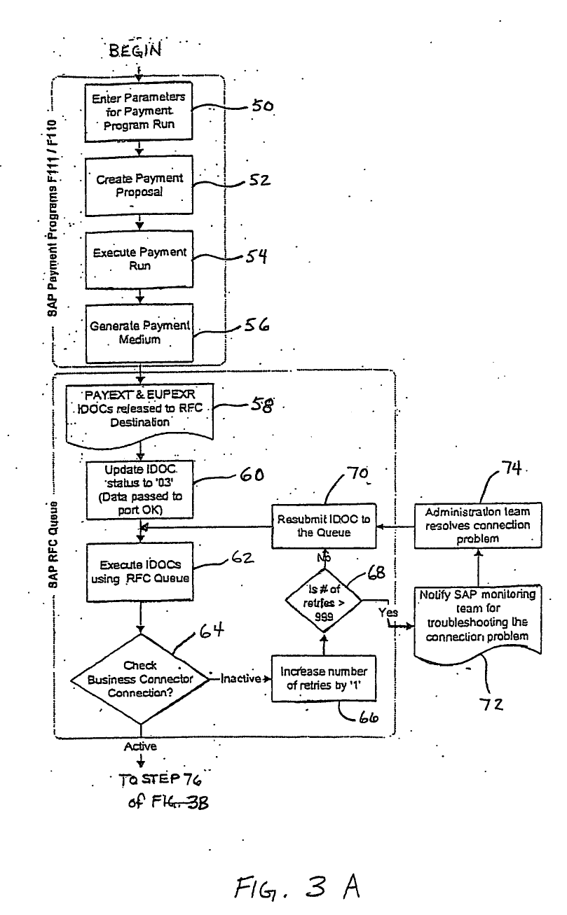

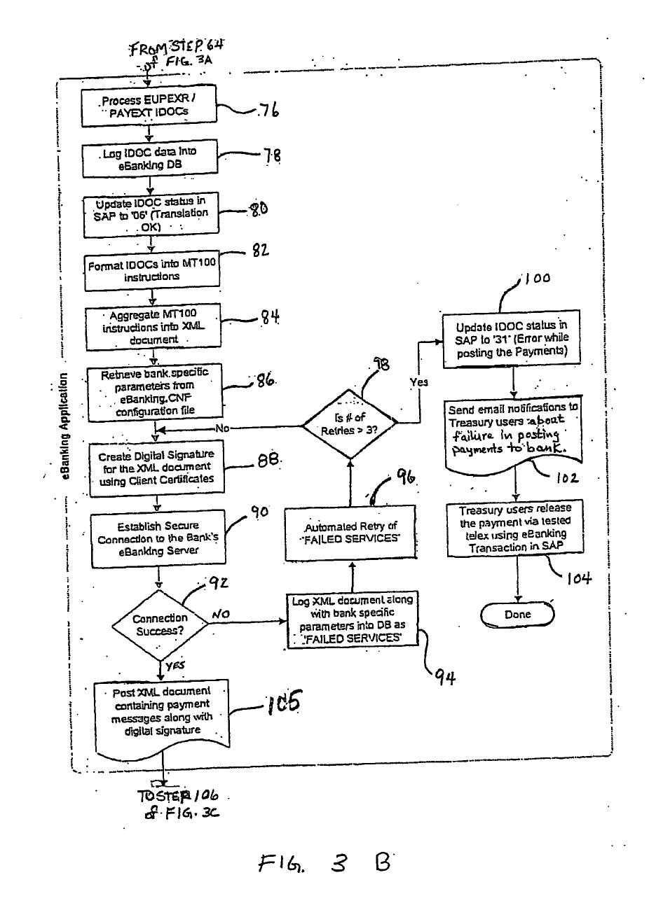

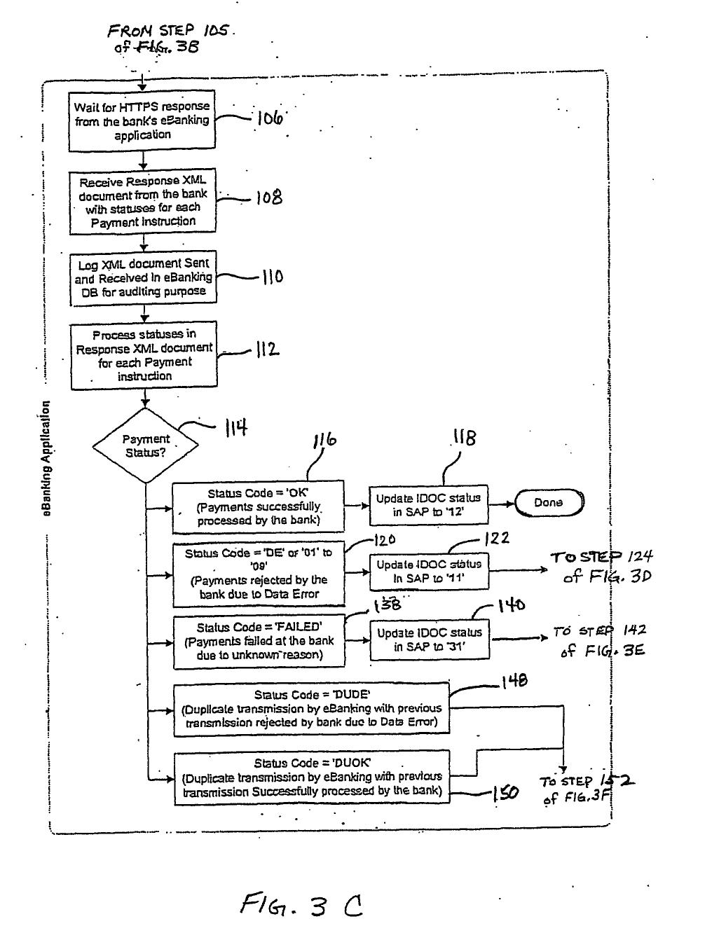

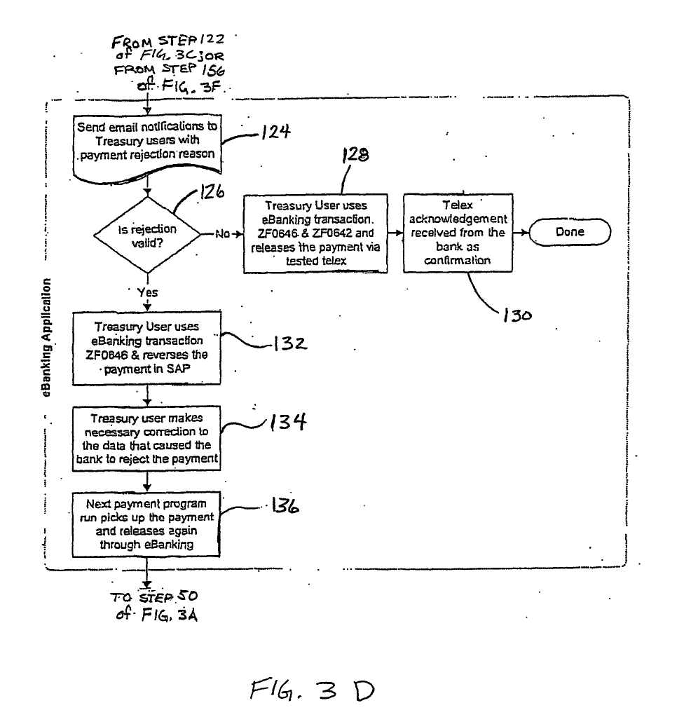

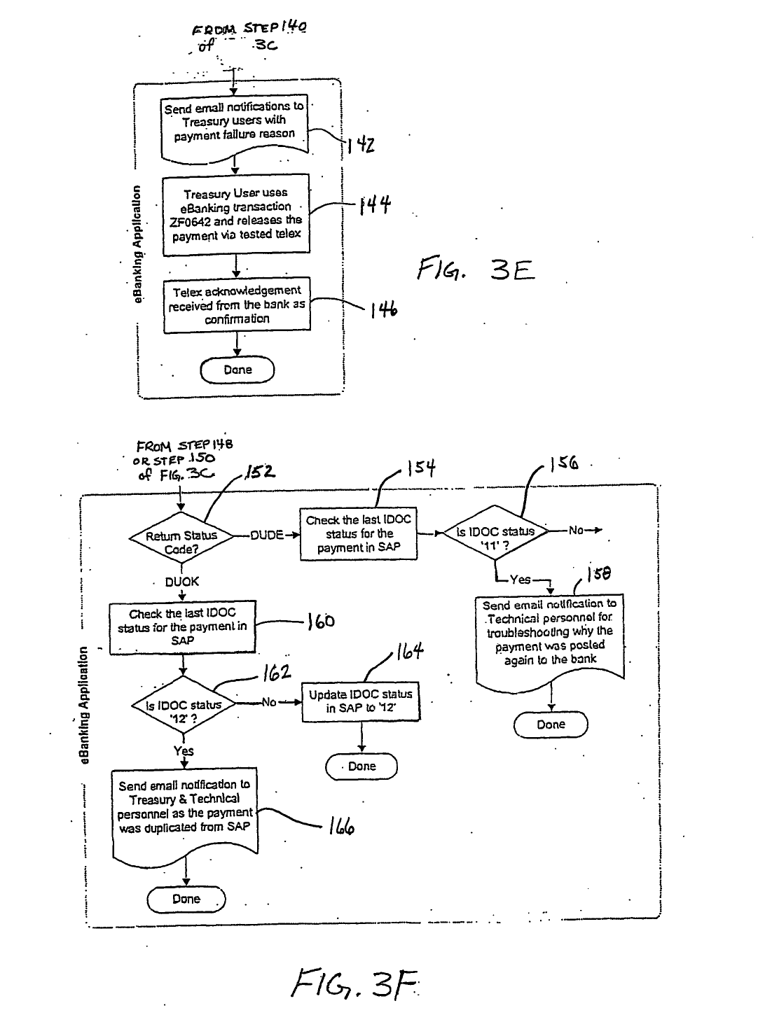

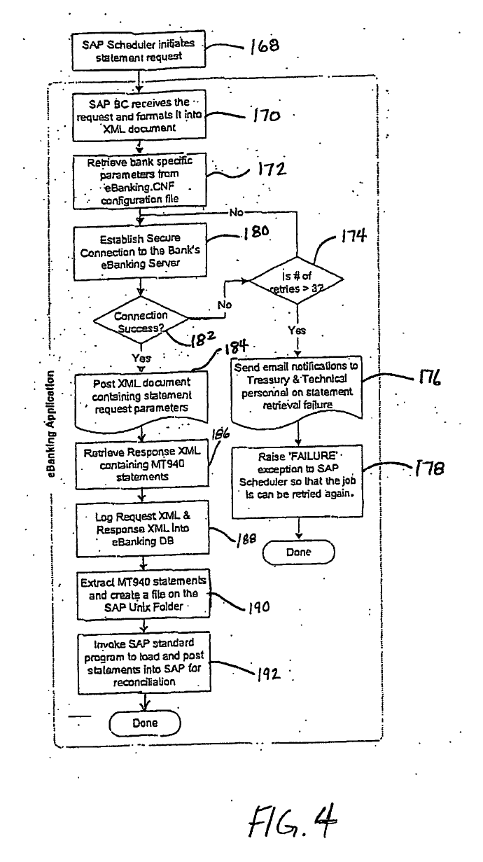

Referring to FIG. 3A, a flowchart is shown to illustrate the payment mode of the system 10 in accordance with the principles of the present invention. In initiating payment, the core transaction component 12 automatically selects transactions (e.g., vendor invoices and employee payments) for payment through execution of a payment program (i.e., transactions F110 and F111 in SAP®), in this example. The algorithm of the system 10 begins in step 50 with the retrieval from the core transaction database 34 of parameters for preparing a payment proposal or transaction order by the payment program. Examples of parameters for the payment proposal can include typical payment transaction parameters such as, for example, posting date (i.e., date on which the payable has been approved for payment), next payment run on date (i.e., posting data of the next payment run which is used to assess the due date of payables), company code (i.e., list of company codes or company code intervals that are to be processed together), payment method (e.g., check, bill of exchange, and bank transfer abroad) and vendor/customer accounts (i.e., range of vendor/customer accounts to be taken into consideration).

In step 52, the core transaction component 12 generates a transaction proposal to allow the user to view all outgoing transaction orders including payments that the core transaction component 12 will process. This allows the user via computer 32 to implement an initial crosscheck before actually posting the transactions for payment. The algorithm proceeds to step 54 where the payment program is executed by the core transaction component 12 to generate a payment document or instrument in preparation for release. In step 56, the algorithm determines the proper format of the payment document or instrument including arrangement and selection of the parameters based on the corresponding payment methods using SAP® R/3 programs such as “ZFR00440” for USD (U.S. Dollar) check payments, “RFF0EDl1” for electronic fund transfer (EFT) payments and the like, for example.

The payment document is generated in the form of an intermediary document (IDOC) and released to the core interface component 14 in step 58. In one example, for EFT payments, the payment program generates two types of documents “PAYEXT” IDOCs and “EUPEXR” IDOCs. Each PAYEXT IDOC contains the payment information for one payee per bank. The EUPEXR IDOC is a reference IDOC generated for each bank and contains all the summary information of the payment instruments released to the corresponding host bank with a list of the PAYEXT IDOC numbers. In SAP® R/3, for this example, the IDOCs are delivered to the core interface component 14 via a remote function call (RFC) Destination Port As soon as the IDOCs are delivered in step 60, the core transaction component 14 updates the IDOC statuses to “03” with a message “Data passed to port OK” indicating that the data has passed correctly to the port, in this example.

The IDOCs received by the core interface component 14 are stored and arranged in a RFC queue in step 62. The EUPEXR IDOCs are received and the summary information along with PAYEXT IDOC numbers are mapped and stored as tables referred herein as T_BC_PAYMENT_REFERENCE and T_BC_PAYMENT_REFERENCE_DETAIL.

In step 64, the algorithm checks to determine if the communication link 24 to core interface component 14 is active. If the server 25 of the core interface component 14 is down or inactive, SAP® R/3 queues all IDOCs in the RFC queue until it is up again. The queue is configured such that pending IDOCs are sent again to the RFC port every minute until the transmission is successful or the number of tries reaches 999 times. For each transmission, the number of retries is increased or incremented by one in step 66. The algorithm queries whether the number of tries is greater than 999 in step 68. If the query is “No”, the algorithm proceeds to step 70 wherein the IDOCs are resubmitted to the RFC queue. Otherwise, the algorithm proceeds to step 72 wherein the SAP® monitoring personnel are advised of the connection problem to allow troubleshooting to be initiated. In step 74, the monitoring personnel resolves the connection problem and proceeds to step 70 for resubmission. The SAP® monitoring personnel are generally composed of employees of the customer and are authorized by the customer to monitor the systems, servers, components and processes forming part of the system of the present invention including both the hardware and software aspects thereof. The monitoring personnel are prepared to implement the appropriate actions to correct or troubleshoot any irregularities that may arise during operation.

If the connection is determined to be active in step 64, the algorithm proceeds to step 76 of FIG. 3B.

In step 76 of FIG. 3B, the core interface component 14 receiving the PAYEXT IDOCs with payment information and maps the IDOC parameter fields to appropriate variables. In step 78, the core interface component 14, that is interface server 25, is programmed to store the IDOCs in the core interface database memory 36 also referred as an eBanking DB (database) in the form of a database table referred herein as T_BC_PAYMENT_TRANSACTION. Next, in step 80, the core interface component 12 of the local server 21, is programmed to, update the IDOC statuses in the core transaction component 12 of the local server 25 to “06” with a message “Translation OK” by using a SAP® RFC call to the core interface component 14 (interface server 25, in this example).

In step 82, the core interface component 14 formats the IDOCs into “MT100” instructions (i.e., Customer Transfer) which complies with the standard format implemented by the Society for Worldwide Interbank Communication. The generated MT100 instructions are then compiled in step 84 into a transaction document formatted in extensible markup language (XML). This action is accomplished by retrieving all payment instructions from the T_BC_PAYMENT_TRANSACTION table for all IDOC numbers matching the information received through the reference IDOC (i.e., EUREXR IDOC). This process is executed to compile payment instructions according to the host bank for subsequent transmission and posting as a single document to the corresponding host bank server 20. The maximum number of payment instructions per transaction document depends on the host bank. The particular requirements for proper preparation and delivery of the transaction document for each bank are stored in a configuration file referred herein as an EBANKING.CNF configuration file.

The transaction documents formatted into SWIFT MT100 (SWIFT is for “Society for Worldwide Interbank Communication) and wrapped around corresponding XML tags await delivery to the host bank server 20. In step 86, the bank specific parameters or requirements are retrieved from the EBANKING.CNF configuration file. In step 88, the banking specific parameters are used to prepare all the transaction documents with a digitally signed certificate using a specific commercially available hashing algorithm. The certificate is used to authenticate or digitally sign the document for security purposes prior to delivery. Host bank servers 20 use the digitally signed certificates to verify the authenticity and to ensure that the information contained in the transaction document was not altered during transmission. The algorithm creates a digital signature for the XML transaction document using the bank specific parameters contained in the EBANKING.CNF configuration file.

In step 90, the core interface component 14 establishes a secure connection to a particular host bank server 20. This is accomplished by setting up a secure socket layer (SSL) session. The digitally signed certificate of the transaction document along with a root certificate certification path is used to initiate the session. The algorithm determines whether a successful connection was established in step 92. If the connection is not established, the algorithm proceeds to step 94. The core interface component 14 stores the transaction document along with the bank specific parameters in the core interface database memory 36 in a database table referred herein as T_BC_FAILED_SERVICE. The table logs all failures including the core interface component services. In step 96, the algorithm initiates automatic retry of the delivery of the transaction document. The retry of the failed services is made about every three minutes, in this example.

The algorithm proceeds to query step 98 to determine whether the number of retries is greater than three. Continuous failure to establish connection email notification is sent to a technical support and business team for appropriate corrective action. A report with transaction code “ZF0642” also referred to as a payment status tool, is prepared for the business team or treasury users to view the statuses of all payment instructions released by the core transaction component 12. Options are provided where the business team can retry transmission or generate automated telex/facsimile as contingency methods for posting the transaction documents to the corresponding bank.

The contingency plan or backup options to send payment instruction to the bank can be used in the event that the core interface component 14 or the host bank server 20 are unable to process the payment instruction. In this contingency plan, the transaction document containing the payment instruction is configured into a proper telex format with a summary report for the user of the core transaction component 12 to generate the test codes. The telex is automatically transmitted to the bank.

If the query in step 98 is “Yes”, the algorithm proceeds to step 100, where the IDOC statuses in the core transaction component 12 are changed to “13” with a message “Error while posting the payments” by using a SAP® RFC call to the core transaction component 12. In step 102, an email message is sent to the authorized users of the core transaction component 12 to manually release the transaction document via conventionally established telex transmission. The users executes transaction ZF0642 to view the statuses of the payment instructions released from the core transaction component 12 and produce a telex report for all payments with the status code “13”. The telex report is displayed to the user where the test code is calculated based on a confidential formula provided by the bank. Each bank uses a different formula. A separate report is prepared for each bank indicating all payments that failed.

In step 104, the authorized users release the transaction documents via telex transmission to the host bank and the operation is completed. After a successful transmission, the user updates the IDOC status code to “12”, indicating that the payment was successfully acknowledged by bank.

If the query of step 98 is “No”, the algorithm proceeds to step 88 to begin reestablishment of the secure connection with the host bank server 20.

Once the secure connection to the host bank server 20 is established in step 90 and the query in step 92 is “Yes”, the algorithm proceeds to step 105. In step 105, the core interface component 14 delivers the transaction document containing the payment instructions and the digital signature through the global computer network 16 to the bank interface component 18 of the host bank server 20. The customers bank 27 proceeds to carry out the payment transaction using its retail banking system as is known in the art.

In FIG. 3C, the algorithm proceeds to step 106 where the core interface component 14 awaits from the bank interface component 18, in this example included with the server 20, a response document formatted in XML containing response status codes and messages for each of the payment instructions that were posted to the bank. In step 108, the core interface component 14 receives the response document from the bank interface component 18. All the XML documents communicated between the bank and the customer are logged in the system of the present invention, and generally identified as “Document Sent” and “Document Received”, respectively. In step 110, the return codes and messages of the response document are stored in the core interface database memory 36 in the form of a table referred herein as T_BC_DOCUMENT_RECEIVED for auditing purposes. The core interface component 14 processes the statuses in the response document for each of the payment instructions in step 112. The algorithm proceeds to step 114, wherein the status of each payment instruction is determined by the core interface component.

For return code “OK” in query step 114, the algorithm proceeds to step 116 wherein the MT100 formatted payment instruction is determined to be accepted successfully by the host bank. The core interface component 14 then updates the IDOC statuses in the core transaction component 12 to “12” with a message “Payment successfully acknowledged by the bank” by using a SAP® RFC call to the core transaction component 12. A report listing successful payments can be generated using transaction “ZF0642” as will be described hereinafter.

For return code “DE”, “01” or “09” in query step 114, the algorithm proceeds to step 120 wherein the MT100 formatted payment instruction is determined to be invalid. The payment instruction contains a data validation error. The error is typically contained in the business data due to incorrect master data or profile information inputted by the core transaction component 12. The algorithm proceeds to step 122 wherein the core interface component 14 updates the IDOC statuses in the core transaction component 14 to code “11” signaling the failure of payment acceptance by the bank due to validation. The algorithm proceeds to step 124 of FIG. 3D. In step 124, the core interface component 14 sends email notification to the user of the core transaction component 14 with the appropriate error message from the bank. The algorithm proceeds to query step 126 wherein the validity of the rejection is determined. If the query is “No,” the algorithm proceeds to step 128 wherein the user of the core transaction component 12 initiates transactions “ZF0646” also referred to as a Payment Reversal Tool for setting the IDOC status to “31” and “ZF0642” for implementing payment status reporting, and payment instructions are submitted to the bank via telex transmission. In step 130, a telex acknowledgment is received from the bank as confirmation, and the operation of the system 10 is completed.

If the rejection is determined to be valid in query step 126, the algorithm proceeds to step 132 wherein the user of the core transaction component 12 initiates transaction ZF0646 and reverses payment. In step 134, the user makes the necessary correction to the data that generated the error. In step 136, the corrected payment instruction is reentered into the core transaction component 12 wherein the algorithm proceeds back to step 50 of FIG. 3A.

Referring back to FIG. 3C, for return code “Failed” in query step 114, the algorithm proceeds to step 138 wherein the service or component at the host bank server 20 is determined to have failed. The algorithm proceeds to step 140 wherein the return code is treated as a technical failure on the bank side, and wherein the core interface component 14 updates the IDOC statuses in the core transaction component 14 to code “13” with the message “Error while posting the payment instruction” signaling the failure of payment acceptance by the bank due to technical problems. The algorithm proceeds to step 142 of FIG. 3E. In step 142, the core interface component 14 sends an email notification to the user of the core transaction component 12 along with the reason for payment rejection due to technical difficulties. The algorithm proceeds to step 144 wherein the user of the core transaction component 12 initiates transaction “ZF0642” for payment reporting, and payment instructions are submitted to the bank via telex transmission. In step 146, a telex acknowledgment is received from the bank as confirmation, and the operation of the system 10 is completed.

Referring back to FIG. 3C, for return code “DUDE” or “DUOK” in query step 114, the algorithm proceeds to step 148 or step 150, respectively, wherein the payment instruction is determined to be a duplicate. The “DUDE” return code is returned by the bank for payments that were rejected with a DE error. The “DUOK” return code is returned by the bank server 20 for payments accepted in a previous transmission. In either of the steps 148 or 150, the algorithm proceeds to step 152 of FIG. 3F. In query step 152, the core interface component 14 determines whether the return code is “DUDE” or DUOK”. If the return code is “DUDE”, the algorithm proceeds to step 154 where the core interface component 14 checks the last IDOC status of the payment instruction in the core transaction component 12. In query step 156, the core interface component 14 determines whether the status code is “11” or payment rejected by bank. If the query is “No,” then the algorithm proceeds to step 124 of FIG. 3D. If the query is “Yes,” the algorithm proceeds to step 158 wherein the core interface component 14 sends an email notification to the technical personnel for troubleshooting why the payment was posted again, and the operation of the system 10 is completed.

In query step 152, if the return code is “DUOK”, the algorithm proceeds to step 160 where the where the core interface component 14 checks the last IDOC status of the payment instruction in the core transaction component 12. In query step 162, the core interface component 14 determines whether the status code is “12” or payment successfully acknowledged by bank. If the query is “No”, then the algorithm proceeds to step 164 where the core interface component 14 updates the IDOC statuses in the core transaction component 14 to code “12” with the message “payment successfully acknowledged by bank”. The operation of system 10 is completed.

In query step 162, if the answer is “Yes”, then the algorithm proceeds to step 166, in which the core interface component 14 sends an email notification to the users of the core transaction component 12 and the technical personnel that a payment was duplicated and corrective action is to be taken. The operation of the system 10 is completed.

It is noted that the payment instructions transmitted to the host bank server 20 should not be repaired automatically by the bank interface component 18 if errors are present All payment instructions with errors are returned to the core interface component 14 with a detail message and return codes.

The core interface component 14 can be configured to generate a payment advice report for all successful payments (i.e., status code “12”) using transaction “ZF0642”.

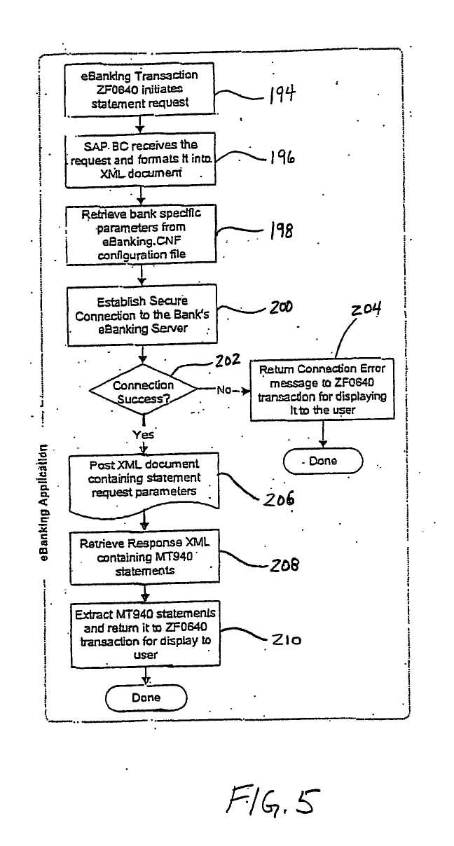

Referring to FIG. 4, a flowchart detailing the operation of the system 10 is shown for another mode of operation and embodiment of the invention. Bank statements are typically retrieved once a day after banking hours and at an agreed upon time for automatic reconciliation. Typically, the time would be in the early morning on the next day. Data received from the bank contains information as to the nature of each transaction in the bank statement. For example, a transaction code is indicated to show, for example, a check payment transaction, an electronic payment, a bank transfer or a customer receipt.

Reference information (e.g., check number, reference number) relative to each item can also be included in the bank statement. Based on the information contained in the bank statement, all outstanding transactions stored in the core transaction component 12 can automatically be cleared when reconciled. The electronic bank statement is received and converted into a format recognizable by the core transaction component 12 by the core interface component 14.

In step 168, the core transaction component 12 initiates a statement request which is sent to the core interface component 14. In step 170, the core interface component 14 receives the statement request and converts it into an XML document In step 172, core interface component 14 retrieves the requirement parameters from the EBANKING.CNG configuration file to establish a secure socket layer (SSL) session through the global computer network 16. A secure connection to the host bank server 20 via the bank interface component 18 is established in step 180. The algorithm proceeds to query step 182 to determine whether a connection was successfully established. If the query is “No”, then the algorithm proceeds to query step 174 to determine if the number of tries is greater than three. If the query is “No”, the algorithm proceeds back to step 180. If the query in query step 174 is “Yes”, the algorithm proceeds to step 176 where the core interface component 14 sends an email notification to the user of the core transaction component 12 and technical personnel to alert them of a connection problem. In step 178, the core interface component 14 raises a “Failure” exception to the core transaction component 12 to manually reinitiate the statement request.

If a successful connection is established, the algorithm proceeds to step 184 where the XML statement request is posted by the core interface component 14 of the interface server 25 to the host bank server 20 via the global computer network 16. The host bank server 20 sends a request response containing the bank statement to the associated bank interface component 18 where the statement, an MT940 statement, is converted into XML, and then forwarded to the core interface component 14 via the global computer network 16 in step 186. In step 188, the core interface component 14 stores the statement request and request response in the core interface database 36 in the form of a table referred herein as T_BC_DOCUMENT_SENT and T_BC_DOCUMENT_RECEIVED, respectively, for auditing purposes. In step 190, the bank statement formatted in MT940 in accordance with SWIFT standard is extracted from the request response and stored in the core transaction component 12. In step 192, the core transaction component 12 imports the data contained in the bank statement to reconcile the transactions. The operation of the system 10 is completed.

Referring to FIG. 5, a flowchart detailing the operation of the system 10 is shown for another mode of operation, and for another embodiment of the invention. Online bank statement access is provided for the user, via computer 32 in this example, in the present invention for viewing statements in real-time directly from the host bank server 20. The statement viewing access is provided only for viewing purposes and not for reconciliation. In step 194, in response to a user request, the core transaction component 12 initiates a statement request through transaction “ZF0640” also referred to as an On-line Statement Report Tool for viewing online bank statements. In step 196, the core interface component 14 receives the statement request and formats the request into an XML document In step 198, the core interface component 14 retrieves the bank specific requirements to establish a SSL connection with the host bank server 20 via the global computer network 16. Attempts to establish a secure connection is made in step 200. In query step 202, the core interface component 14 determines whether a secure connection has been established. If the query is “No”, the algorithm proceeds to step 204 where a return connection error message corresponding to the “ZF0640” function is displayed to the requesting user and the operation of the system 10 is completed.

If the query in query step 202 is “Yes”, the algorithm proceeds to step 206 where the statement request containing statement request parameters is posted to the bank interface component 18. The bank interface component 18 processes the statement request for upload to the host bank server 20. The host bank server 20 generates a bank statement in the format of SWIFT MT940 to the bank interface component 18. The bank interface component 18 converts the bank statement into an XML format and transmits it to the core interface component 14. In step 208, the core interface component 14 receives the bank statement. In step 210, the core interface component 14 processes the MT940 data from the bank statement into a structured output and uploads the output to the core transaction component 12 for display to the user.

Although various embodiments of the invention have been shown and described in detail above, they are not meant to be limiting. Those of skill in the art may recognize certain modifications to these embodiments, which modifications are meant to be covered by the appended claims. For example, although a global computer network 16, such as the Internet is illustrated for providing a data connection path, or link between a customer's local server 21 and the bank's server 20, the network 16 can also be a local area network (LAN) for communicating within a large building where the customer and their bank is located, or a wide area network (WAN) where the customer and their bank is located in a common business park, for example.

I claim:

1. A method for an automated banking system for permitting a customer of a bank to remotely authorize and request a computerized monetary transaction be made by their bank, said method comprising the steps of:
providing a computerized system at the customer's location;
receiving on the customer's system, a customer's manually inputted request for the customer's bank to conduct a monetary transaction;
automatically running on the customer's system, in response to a request, a monetary transaction program for generating a properly formatted monetary transaction document as an intermediary document (IDOC);
automatically retaining in the customers system the IDOC in a remote function call (RFC) queue, for a predetermined period of time, to permit the IDOC to be passed into an eBanking interface server of the customers system for further processing;
programming said interface server to automatically convert the IDOC into an extensible markup language (XML) formatted document;
automatically transferring over a computer network the XML formatted IDOC from the customer's system to a compatible eBanking server in the customer's bank; and
automatically processing the requested monetary transaction via said server of said bank responding to the IDOC.

2. The method of claim 1, further including the steps of:
automatically operating the bank's eBanking server to send an XML formatted status document to said customer;
automatically receiving said status document on the customer's system;
operating the customer's system to permit the customer to read the received status document; and
automatically logging the received status document into a core transaction database memory in the customer's system.

3. The method of claim 1, wherein said step of automatically running said monetary transaction program includes the steps of:
entering parameters for the requested monetary transaction;
creating a monetary transaction proposal; and
executing a monetary transaction run to generate said IDOC.

4. The method of claim 1, wherein said RFC queue retaining step includes the steps of:
releasing the IDOC to the RFC destination of the eBanking server in the customer's bank;
updating the IDOC status to a digitized code indicative of data being successfully passed to a port;
executing the IDOC received at the port into an RFC queue; and
checking to determine if a communication link to said server in the customer's bank is active or inactive.

5. The method of claim 4, further including the steps of:
responding to said interface server of said bank being inactive by increasing a number of retries counter by “1”;
determining if the number of retries is greater than a predetermined maximum number; and
resubmitting the IDOC to the RFC queue if the number of retries does not exceed the maximum number; and
a repeating said checking step.

6. The method of claim 5, further including the steps of:
responding to the number of retries being greater than the predetermined number, by notifying troubleshooting personnel of a problem in establishing a communication link with said interface server of the bank;
resubmitting the IDOC to the RFC queue in response to a communication that the linkage problem has been resolved; and
repeating said checking step.

7. The method of claim 4, further including the steps of:
responding to an active interface server by mapping the IDOC parameter fields to appropriate variables;
storing IDOC data in an eBanking DB (database);
updating the IDOC status to indicate acceptable translation;
formatting the IDOC into instructions complying with a standard format implemented by the Society for Worldwide Data Bank Communication;
compiling the formatted IDOC and subsequent formatted IDOCs each into a transaction document formatted in extensible markup language (XML);
retrieving bank specific parameters from an eBanking.CNF configuration file;
creating a digital signature for each XML formatted document using client certificates;
establishing a secure connection to the computer server in the customer's bank;
determining whether a secure connection was successfully established; and
responding to a successfully established secure connection by transferring over a computer network each transaction document containing transaction instructions and a digital signature to the computer server in the customer's bank.

8. The method of claim 7, further including the steps of:
responding to a failure to establish a secure connection by logging the XML document along with bank specific parameters into a database labeled “Failed Services”;
automatically retrying the successive steps of creating a digital signature, establishing a secure connection, and determining if a secure connection has been established;
determining whether the number of retries is greater than a predetermined maximum number; and
continuing said step of automatically retrying if the number of retries is not greater than the maximum number.

9. The method of claim 8, further including the steps of:
responding to the number of retries exceeding the maximum number, by updating the IDOC status to a code indicative of an error while posting payments;
sending an e-mail notification to an authorized officer of customer for release of the payment via prior conventionally established telex or facsimile transmission;
responding to the e-mail, the authorized officer releases or provides the monetary transaction documents via telex or facsimile to the bank; and
updating an IDOC status code to indicate the monetary transaction successful completion has been acknowledged by the bank.

10. The method of claim 7, further including the steps of:
waiting for a response over the computer network from the bank;
receiving from the bank a response document formatted in XML containing response status codes and messages for each of the monetary payment instructions posted to the customer's bank;
storing in an eBanking database the response document;
processing the statuses in the response document for each of the associated monetary transactions instructions; and
determining the status from the bank of each monetary transaction.

11. The method claim 10, wherein the step of determining the status of each monetary transaction includes the steps of:
indicating a status code equivalent to “OK” for monetary transactions successfully processed by the bank; and
updating related IDOC statuses to have a code indicative of the bank having advised the monetary transaction was successfully made.

12. The method of claim 10, further including the steps of:
indicating a status code corresponding to a Data Error causing the bank to reject the monetary transaction; and
updating the IDOC status for the transaction to a code indicative of the transaction rejection due to a Data Error.

13. The method of claim 12, further including the steps of:
sending an e-mail notification to an authorized officer of customer indicating the reason for rejection of the monetary transaction;
determining by action of the authorized officer whether the rejection is valid;
responding to a valid rejection by action of the authorized officer to use an eBanking transaction request to reverse the monetary transaction request;
correcting via action of the authorized officer, the data that caused the bank to reject the monetary transaction; and
reprocessing the corrected monetary transaction through said banking system for completion.

14. The method of claim 13, further including the steps of:
responding to an invalid rejection by action of the authorized officer using appropriate eBanking transaction codes for releasing the monetary transaction via tested telex transmission to the bank; and
receiving via the customer's computer system an acknowledgment from the bank confirming completion of the monetary transaction.

15. The method of claim 10, further including the steps of:
indicating a status code corresponding to “Failed” for the bank failing to complete the monetary transaction for unknown reasons; and
updating in response to the “Failed” code the IDOC status to a code indicative of the failed monetary transaction.

16. The method of claim 15, further including the steps of:
sending via e-mail notification from the bank to the authorized officer the reasons for the failure by the bank to complete the monetary transaction;
releasing by action of the authorized officer using an appropriate eBanking transaction code via tested telex or facsimile authorization to the bank to complete the monetary transaction; and
receiving via telex or facsimile from the bank to the customer confirmation that the monetary transaction was completed.

17. The method of claim 10, further including the steps of:
indicating from the bank either a return status code corresponding to “DUDE” for a duplicate transmission by eBanking of a previous transmission rejected by the bank due to a Data Error, or corresponding to “DUOK” for a duplicate transmission by eBanking of a previous transmission successfully processed by the bank;
determining via the customer's computer system whether the return status code corresponds to DUDE or DUOK;
determining in response to a status code of DUDE whether the last IDOC status for the monetary transaction is indicative of the transaction being rejected by the bank due to a Data Error;
sending, in response to a rejection due to a Data Error, an e-mail notification to technical personnel for troubleshooting the reasons the monetary transaction was posted in duplicate to the bank; and
sending, in response to a rejection not being due to a Data Error, an e-mail notification to an authorized officer of customer to indicate reasons monetary transaction was rejected by bank.

18. The method of claim 17, further including the steps of:
determining in response to a status code of “DUOK” whether the last IDOC status for the monetary transaction is indicative of successful processing of the transaction by the bank;
changing the IDOC status to a code indicative of successful processing, in response to a No answer in the immediately previous determining step; and
sending an e-mail notification to an authorized officer of customer and customer's technical personnel, in response to a Yes answer in the previous associated determining step, for indicating the monetary transaction was duplicated in said automated banking system.

19. The method of claim 1, further including the steps of:
initiating, by action of the customer using a scheduler, a request for a bank statement;
passing the request to said interface server of customer for conversion into an XML document;
retrieving required parameters from an eBanking configuration file necessary to establish a secure socket layer (SSL) session over said computer network;
establishing over said computer network a secure connection to the bank's eBanking server;
determining if the connection is successfully established;
determining in response to an unsuccessful connection whether a number of retries is greater than an allowed maximum number;
repeating said secure connection establishing step in response to the number of retries not exceeding the maximum number;
sending an e-mail, in response to the number of retries exceeding the maximum number, to an officer of customer and technical personnel to advise of the connection or statement retrieval failure; and
raising a “Failure” exception to the scheduler for permitting a manual request for the statement.

20. The method of claim 19, further including the steps of
responding to a successful connection in said secure connection establishing step by posting the XML document containing statement request parameters to the bank's eBanking server;
retrieving on customers system statement(s) in XML formatted responses from the bank;
storing both the XML formatted request(s), and response(s), in an eBanking database of the customer,
retrieving the statement(s) from the eBanking database to create a file in a designated folder; and
reconciling the statements through use of standardized banking business software.

21. The method of claim 1, further including the steps of:
initiating by action of the customer using an eBanking transaction code for requesting a statement showing the completed monetary transaction(s);
converting, via said interface server of customer, the request into an XML formatted document;
retrieving required parameters from an eBanking configuration file necessary to establish a secure connection over the computer network to an eBanking server of the bank;
establishing over said computer network a secure connection to the bank's eBanking server;
determining if the connection is successfully established; and
responding to the unsuccessful establishment of the connection by returning a connection error message for display to the customer.

22. The method of claim 21, further including the steps of:
responding to the successful establishment of the connection by posting to the eBanking server of the bank the XML document containing the statement request parameters;
receiving on the eBanking interface server of the customer a response from the bank of an XML formatted statement; and
extracting the statement(s) for display to the customer.

23. An automated electronic banking system for initiating and automatically
processing monetary transactions, said system comprising:
initiating means for permitting a remotely located customer of a bank to selectively initiate a monetary transaction request for automated processing;
a bank host server adapted for automatically receiving and processing said monetary transaction request;
a computer network in data communication between said bank host server means and said initiating means, for transmitting the payment transaction request from the customer's initiating means to the bank host server; and
interface means located between said initiating means and said computer network, for automatically interfacing the initiating means to the bank host server, and for converting said monetary transaction request into a readable form compatible with the bank host server.

24. The system of claim 23, further including:
security means for establishing a secure transfer of data between said initiating means and said bank host server.

25. The system of claim 23, further including:
programming means for operating said initiating means, interfacing means, and bank host server to automatically respond to said monetary transaction request, whereby said bank host server completes the monetary transaction, and insures the production of all necessary electronic records detailing every necessary tracking step carried out in completing the payment transaction.

26. The system of claim 23, wherein said initiating means includes:
at least one computer for permitting a customer to generate said monetary transaction request;
a local computer server of customer connected between said at least one computer and said interfacing means; and
a core transaction database memory for storing necessary computer programs for operating said local computer server, to respond to customer's monetary transaction request by preparing a monetary transaction order in the form of intermediary documents (IDOC), and all necessary tracking records for various associated payment parameters.

27. The system of claim 26, wherein said interfacing means includes:
an interface computer server of customer connected between said local computer server and said computer network; and
a core interface database memory for storing necessary computer programs for operating said interface computer server to convert communications from said local computer server into a format for communication over said computer network, and for storing said IDOCs, transaction documents, return codes, and messages related to transactions with said bank host server means.
